(19) United States
(12) Patent Application Publication
(10) Pub. No.: US 2023/0133337 A1
(43) Pub. Date: May 4, 2023

(54) QUANTIZATION CALIBRATION METHOD, COMPUTING DEVICE AND COMPUTER READABLE STORAGE MEDIUM

(71) Applicant: Anhui Cambricon Information Technology Co., Ltd., Hefei (CN)

(72) Inventors: Jiahao ZHOU, Hefei (CN); Yangyang XIA, Hefei (CN); Xishan ZHANG, Hefei (CN)

(21) Appl. No.: 17/619,825

(22) PCT Filed: Jun. 10, 2021
(86) PCT No.: PCT/CN2021/099287

§ 371 Date: Dec. 16, 2021

(30) Foreign Application Priority Data
Jul. 15, 2020 (CN) 202010682877.9

(51) Int. Cl. G06N 3/0495; G06F 18/21

(52) U.S. Cl. CPC G06N 3/0495; G06F 18/2163; G06F 18/217

(57) ABSTRACT

The present disclosure provides a method for calibrating quantization, a computing device and a computer readable storage medium. The computing device is included in the combined processing apparatus, and the combined processing apparatus further includes an interface device and a further processing device. The computing device interacts with the further processing device to jointly complete a computing operation specified by a user. The combined processing apparatus further includes a storage device connected to the computing device and the further processing device and configured to store data of the computing device and the further processing device. The solution of the present disclosure optimizes quantization parameters using a new quantization difference metric, thereby maintaining a certain quantization inference precision while achieving various advantages through quantization.

### CROSS-REFERENCE TO RELATED APPLICATION

The present application claims priority from Chinese patent application No. 2020106828779 titled “METHOD FOR CALIBRATING QUANTIZATION, COMPUTING DEVICE AND COMPUTER READABLE STORAGE MEDIUM”, filed on Jul. 15, 2020, the disclosure of which is incorporated herein in its entirety by reference.

### TECHNICAL FIELD

The present disclosure generally relates to the field of data processing. More specifically, the present disclosure relates to a method for calibrating quantization, a computing device and a computer readable storage medium.

### BACKGROUND OF THE INVENTION

With the development of the artificial intelligence technology, the computation volume of neural network operation becomes larger and larger, and involves more and more computation resources to be consumed. One of the good methods for reducing the computation volume and saving the computation resources is to quantize data in neural network operation.

However, quantization may reduce inference precision. Therefore, quantization calibration is needed to solve the technical problem of achieving certain quantization inference precision while reducing the computation volume and saving computation resources.

### SUMMARY OF THE INVENTION

In order to solve at least the technical problems as mentioned above, the present disclosure proposes, in various aspects, a solution of optimizing quantization parameters using a new quantization difference metric, which can maintain certain quantization inference precision while achieving advantages including reducing the computation volume, saving computation resources, saving storage resources, shortening the processing cycle, and the like through quantization.

In a first aspect, the present disclosure provides a method performed by a processor for calibrating quantization in a neural network, including: receiving a calibration data set; quantizing the calibration data set by using a truncated threshold; determining a total quantization difference metric for the quantization; and determining an optimized truncated threshold based on the total quantization difference metric, where the optimized truncated threshold is used by a processor for quantizing data during a neural network operation. The calibration data set is divided into quantized part data and truncated part data according to the truncated threshold, and the total quantization difference metric is determined based on a quantization difference metric of the quantized part data and a quantization difference metric of the truncated part data.

In a second aspect, the present disclosure provides a computing device for calibrating quantization in a neural network, including: at least one processor; and at least one memory which is in communication with the at least one processor and stores computer readable instructions. The computer readable instructions, when loaded and executed by the at least one processor, cause the at least one processor to perform the method of any one of the embodiments in the first aspect.

In a third aspect, the present disclosure provides a computer readable storage medium storing program instructions which, when loaded and executed by a processor, cause the processor to perform the method of any one of the embodiments in the first aspect.

With the method for calibrating quantization, the computing device and the computer readable storage medium as provided above, the solution of the present disclosure evaluates the quantization performance using a new quantization difference metric, thereby optimizing the quantization parameters and maintaining certain quantization inference precision while achieving various advantages (such as reducing the computation volume, saving computation resources, saving storage resources, shortening the processing cycle, and the like) through quantization. According to the solution for calibrating quantization of the present disclosure, the total quantization difference metric may be divided into: a metric for quantized part data DQ of the input data and a metric for truncated part data DC of the input data. By dividing the input data into two types according to the quantization operation to evaluate the quantization difference, the influence of quantization on effective information of the data can be more accurately characterized, which may facilitate optimization of the quantization parameters, and provide higher quantization inference precision.

### BRIEF DESCRIPTION OF THE DRAWINGS

The above and other objects, features and advantages of exemplary implementations of the present disclosure will become readily understandable by reading the following detailed description with reference to the accompanying drawings. In the accompanying drawings, several implementations of the present disclosure are illustrated by way of example but not limitation, and like or corresponding reference numerals indicate like or corresponding parts, in which:

FIG. 1 is a schematic block diagram of a neural network to which an embodiment of the present disclosure may be applied;

FIG. 2 is a schematic diagram of a hidden layer forward propagation process in a neural network involving a quantization operation to which an embodiment of the present disclosure may be applied;

FIG. 3 is a schematic diagram of a hidden layer backward propagation process in a neural network involving a quantization operation to which an embodiment of the present disclosure may be applied;

FIG. 4 is a schematic diagram of a quantization operation to which an embodiment of the present disclosure may be applied;

FIG. 5 is a schematic diagram showing quantization errors of the quantized part data and truncation errors of the truncated part data;

FIG. 6 is a schematic flowchart of a method for calibrating quantization according to an embodiment of the present disclosure;

FIG. 7 is a schematic logic flow for implementing the method for calibrating quantization according to an embodiment of the present disclosure;

FIG. 8 is a block diagram showing hardware configuration of a computing device that may implement the solution for calibrating quantization according to an embodiment of the present disclosure;

FIG. 9 is a schematic diagram showing an application in which the computing device according to an embodiment of the present disclosure is applied to an artificial intelligence processor chip.

FIG. 10 is a structural diagram of a combined processing apparatus according to an embodiment of the present disclosure; and

FIG. 11 is a schematic structural diagram of a board card according to an embodiment of the present disclosure.

### DETAILED DESCRIPTION OF THE INVENTION

The technical solutions in the embodiments of the present disclosure will be described clearly and completely below with reference to the accompanying drawings in the embodiments of the present disclosure. Obviously, the described embodiments are some but not all embodiments of the present disclosure. All other embodiments obtained by those skilled in the art based on the embodiments of the present disclosure without paying any creative effort shall be included in the protection scope of the present disclosure.

It should be understood that the terms “first”, “second”, “third”, and the like that may be used in the claims, description, and drawings of the present disclosure are used to distinguish between different objects, and are not intended to describe a particular order. The terms “includes” and “including”, when used in the description and claims of the present disclosure, specify the presence of stated features, integers, steps, operations, elements, and/or components, but do not preclude the presence or addition of one or more other features, integers, steps, operations, elements, components, and/or groups thereof.

It is also to be understood that the terminology used in the description of the disclosure herein is for the purpose of describing specific embodiments only, and is not intended to be limiting of the disclosure. As used in the description and the claims of the disclosure, the singular forms “a”, “an” and “the” are intended to include the plural forms as well, unless the context clearly indicates otherwise. It should be further understood that the term “and/or” as used in the description and claims of the disclosure refers to any and all possible combinations of one or more of the associated listed items and includes such combinations.

As used in the description and the claims, the term “if” may be interpreted contextually as “when” or “once”, or “in response to determining”, or “in response to detecting. “Similarly, the phrase “if it is determined” or “if [the described condition or event] is detected” may be interpreted contextually as “upon determining” or “in response to determining” or “upon detecting [the described condition or event]” or “in response to detecting [the described condition or event].”

Definitions of technical terms that may be used in the present disclosure are firstly given below.

Floating point number: a number represent by V=(−1) \hat{ }sign*mantissa*2 \hat{ }E according to the IEEE floating point standard, where “sign” represents a sign bit, 0 represents a positive number, and 1 represents a negative number; E represents an exponent to weight the floating point number, and the weight is E power of 2 (possibly negative power); mantissa represents a mantissa, which is a binary decimal having a range of 1˜2−ε or 0−ε. The representation of the floating point number in the computer is divided into three fields which are encoded separately:

(1) a single sign bit s that directly encodes the sign s;
(2) a k-bit exponent field that encodes the exponent, exp=e(k−1) . . . e(1)e(0); and
(3) an n-bit decimal field mantissa that encodes the mantissa. However, the encoded results depend on whether the exponent phase is all 0.

Fixed point number: a number composed of a shared exponent, a sign bit (sign) and a mantissa, where the shared exponent means that the exponent is shared in a real number set to be quantized; the sign marks positive or negative of the fixed point number; and the mantissa decides the count of significant digits, or precision, of the fixed point number. Taking a 8-bit fixed point number type as an example, the value of the number may be calculated by:

value=(−1)^{sign}×(mantissa)×2^{(exponent-127)}

Kullback-Leibler (KL) divergence: also called relative entropy, information divergence, or information gain. The KL divergence is a metric of asymmetry of the difference between two probability distributions P and Q. The KL divergence is used to measure the count of extra bits averagely required to encode samples from P using Q-based coding. Typically, P represents a true distribution of the data, and Q represents a theoretical distribution, a model distribution, or an approximate distribution of P of the data.

Data bit width: the count of bits used for representing the data.

Quantization: a process of converting a high-precision number expressed by 32 bits or 64 bits into a fixed point number which occupies less memory space, where the fixed point number is generally 16 bits or 8 bits, and the process of converting a high-precision number to a fixed point number may cause certain loss in precision.

The following briefly introduces a neural network environment to which embodiments of the disclosure can be applied.

A neural network (NN) is a mathematical model that mimics structures and functions of a biological neural network, which has a large number of connected neurons for computing. Therefore, the neural network is a computing model composed of a large number of interconnected nodes (or “neurons”). Each node represents a specific output function called activation function. The connection between every two neurons represents a weight value, called weight, of the signal passing through the connection, equivalent to memory of the neural network. The output of the neural network varies depending on different connection manners between neurons, weights and activation functions. For a neural network, neuron is the basic unit of the neural network. The neuron obtains a certain number of inputs and a bias, which is multiplied by a weight when a signal (value) arrives. The connection involves connection of one neuron to another neuron on another layer or the same layer, accompanied by a weight associated with the connection. In addition, the bias is an additional input to the neuron, which is always 1 and has its own connection weight.

In applications, if no nonlinear function is applied to the neurons in the neural network, the neural network is merely a linear function and is not more powerful than a single neuron. If the output of a neural network is set to be between 0 and 1, for example, in the case of cat and dog classification, an output close to 0 may be considered as a cat, and an output close to 1 may be considered as a dog. To achieve this object, an activation function, such as a sigmoid activation function, is introduced into the neural network. With respect to this activation function, it is enough to know that the return value is a number between 0 and 1. Therefore, the activation function is configured to introduce nonlinearity into the neural network, which will narrow the neural network operation result to a smaller extent. The choice of the activation function affects the representation capability of the final network. The activation function may have many forms, each of which parameterizes a nonlinear function by some weights, and the nonlinear function may be changed by changing the weights.

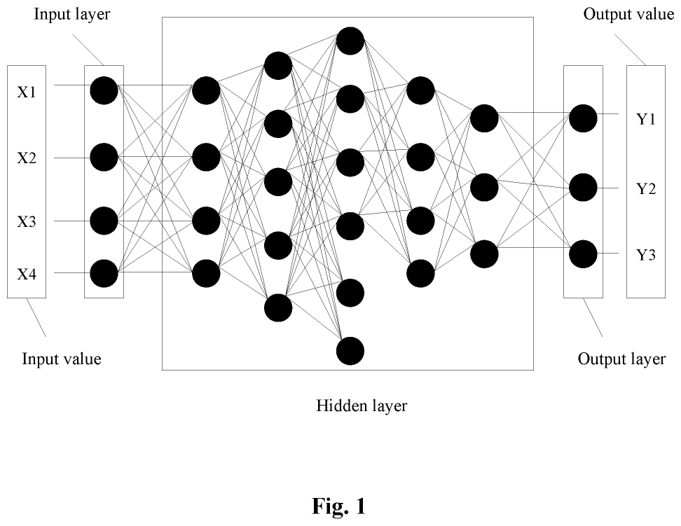

FIG. 1 is a schematic block diagram of a neural network 100 to which an embodiment of the present disclosure may be applied. The neural network shown in FIG. 1 includes three layers, which are an input layer, a hidden layer and an output layer, and the hidden layer shown in FIG. 1 includes 5 layers.

The leftmost layer of the neural network is called an input layer, where the neurons are called input neurons. The input layer, as the first layer in the neural network, receives the required input signals (values) and transfers the signals (values) to the next layer. It generally does not operate on the input signals (values) and has no associated weight or bias. The neural network shown in FIG. 1 includes 4 input signals x1, x2, x3 and x4.

The hidden layer includes different neurons (nodes) that are applied to the input data. The neural network shown in FIG. 1 includes 5 hidden layers. The first hidden layer has 4 neurons (nodes), the second layer has 5 neurons, the third layer has 6 neurons, the fourth layer has 4 neurons, and the fifth layer has 3 neurons. Finally, the hidden layer transfers the computed values of the neurons to the output layer. The neural network shown in FIG. 1 enables full connection of all neurons in the 5 hidden layers. In other words, each neuron in each hidden layer is connected to each neuron in the next layer. It should be noted that not every hidden layer of a neural network is fully connected.

The rightmost of the neural network of FIG. 1 is called an output layer, where the neurons are called output neurons. The output layer receives the output from the last hidden layer. In the neural network shown in FIG. 1, the output layer has 3 neurons, and there are 3 output signals y1, y2 and y3.

In practical applications, a large amount of sample data (including inputs and outputs) is provided to train an initial neural network in advance, and after the training, a trained neural network is obtained. This neural network may give a correct output for a future real-world input.

The loss function needs to be defined before starting to discuss the training of neural network. The loss function is a function that measures performance of the neural network in performing a specific task. In some embodiments, the loss function may be obtained by: transferring, in the training a certain neural network, each piece of sample data along the neural network to obtain an output value, and then calculating and squaring a difference between the output value and an expected value. In this manner, the calculated loss function is a distance between the predicted value and the true value, and the purpose of training the neural network is to reduce this distance or the value of the loss function. In some embodiments, the loss function may be expressed as:

$$L ( y , \hat{y} ) = \frac{1}{m} {\sum }_{i = 1}^{m} {( {y}_{i} - {\hat{y}}_{i} )}^{2} . \qquad ( 1 )$$

In the above equation, y represents an expected value, 9 represents an actual result of each piece of the sample data in the sample data set obtained through the neural network, i is an index of each piece of sample data in the sample data set, L(y, ŷ)) represents an error value between the expected value y and the actual result ŷ, and m represents the count of sample data in the sample data set.

The following takes the practical application scenario of cat and dog classification as an example. Assume that a data set consists of pictures of cats and dogs, and if the picture is a dog, the corresponding label is 1, and if the picture is a cat, the corresponding label is 0. The label here corresponds to the expected value y in the above equation, and when each sample picture is transferred to the neural network, the actual purpose is to obtain the identification result through the neural network, in other words, to know the animal in the picture is a cat or a dog. In order to calculate the loss function, each sample picture in the sample data set should be traversed to obtain an actual result ŷ corresponding to each sample picture, and then the loss function is calculated according to the above definition. If the loss function is relatively large, for example, exceeds a predetermined threshold, it indicates that the neural network has not been trained well yet, and further adjustment of the weights is needed.

When starting training of the neural network, the weights are required to be initialized randomly. In most cases, the initialized neural network does not provide a good enough training result. Assuming that the training is started with an inefficient neural network, a network with a higher precision may be obtained through the training.

The training process of a neural network is divided into two phases, including a first phase involving the forward processing of signals (referred to as the forward propagation process in the present disclosure), in which the training passes from the input layer through the hidden layer and finally reaches the output layer; and a second phase involving the backward propagation gradient operation (referred to as the backward propagation process in the present disclosure), in which the training passes from the output layer to the hidden layer, and finally to the input layer, and the weight and bias of each layer in the neural network are adjusted in turn according to the gradient.

In the forward propagation process, an input value is input to the input layer of the neural network, and after the corresponding computation is performed by correlation operators of a plurality of hidden layers, the predicted value may be obtained from the output layer of the neural network. When the input value is provided to the input layer of the neural network, the input layer may not perform any operation or may perform some necessary pre-processing depending on the application scenario. Among the hidden layers, the second hidden layer obtains a predicted intermediate result value from the first hidden layer, performs computing and activation on the value, and then transmits an obtained predicted intermediate result value to the next hidden layer. The same operations are performed in the subsequent layers, and finally, an output value is obtained from the output layer of the neural network. After the forward processing through the forward propagation process, an output value, called the predicted value, is usually obtained. To calculate the error, the predicted value may be compared with the actual output value to obtain a corresponding error value.

In the backward propagation process, the chain rule in the differential science may be used to update the weight of each layer, so that a lower error value than the previous one may be obtained in the next forward propagation process. In the chain rule, a derivative of the error value corresponding to the weight of the last layer of the neural network is firstly calculated. The derivative is referred to as gradient, which is then used to calculate a gradient of the second last layer in the neural network. The process is repeated until the gradient corresponding to each weight in the neural network is obtained. Finally, the corresponding gradient is subtracted from each weight in the neural network, so that the weights are updated once to reduce the error value. Similar to the use of various operators (referred to as forward operators in the present disclosure) in the forward propagation process, there are backward operators in the corresponding backward propagation process that correspond to the forward operators in the forward propagation process. For example, convolution operators in a convolution layer include forward convolution operators in the forward propagation process and backward convolution operators in the backward propagation process.

For the neural network, tuning refers to loading a trained neural network. Similar to the training process, the tuning process is divided into two phases, including a first phase involving the forward processing of signals (called the forward propagation process in the present disclosure), and a second phase involving the backward propagation gradient (called the backward propagation process in the present disclosure), in which the weights of the trained neural network are updated. The difference between the training and the tuning lies in that the training processes an initialized neural network randomly and trains the neural network from scratch, while the tuning is not.

During the training or tuning of the neural network, each time the neural network experiences a forward propagation process of the forward processing on signals and a backward propagation process of the corresponding errors, weights in the neural network are updated once by using the gradients, the process is called a iteration. To obtain a neural network with a desired accuracy, a very large sample data set is needed during the training process, but it is almost impossible to input the sample data set into a computing apparatus (e.g., a computer) at once. Therefore, in order to solve this problem, the sample data set is required to be divided into a plurality of batches, and transmitted to the computer in batches. After each batch of data set is subjected to the forward processing in the forward propagation process, the operation of updating the weights in the neural network is correspondingly performed once in the backward propagation process. When a complete sample data set has been subjected to the forward processing once in the neural network, and one operation of corresponding weight update is returned, the process is called an epoch. In practice, it is not enough to transfer a complete data set once in a neural network, and the complete data set is required to be transmitted multiple times in the same neural network. In other words, a plurality of epochs are required before finally obtaining the neural network with the expected accuracy.

During the training or tuning of the neural network, the user usually wants the training or fine-tuning to be performed with a speed as fast as possible and an accuracy as high as possible, but such expectation is usually influenced by the type of the neural network data. In many application scenarios, the neural network data is represented in a high-precision data format (e.g., floating point numbers). Taking the convolution operation in the forward propagation process and the backward convolution operation in the backward propagation process as examples, when these two operations are performed on a computing apparatus central processing unit (“CPU”) and a graphics processing unit (“GPU”), almost all the inputs, weights, and gradients are floating point type data in order to ensure data precision.

Taking the floating point type format as an example of the high-precision data format, it can be known from the computer architecture that based on computation representation rules of the floating point number and the fixed point number, for a floating point computation and a fixed point computation of the same length, the floating point computation involves a more complicated computing mode and requires more logic devices to construct a floating point computation unit. In terms of the volume, the floating point computation unit has a volume lager than the fixed point computation unit. Further, the floating point computation unit consumes more resources in processing, so that the power consumption difference between the fixed point computation and the floating point computation is typically in orders of magnitude, thereby leading to significant difference in the computing cost. However, according to experiments, the fixed point computation is faster than the floating point computation and the precision loss involved is acceptable. Therefore, it is feasible to adopt the fixed point computation in the processing of a great amount of neural network operation (such as convolution and full connection computations) in an artificial intelligence chip. For example, all floating point type data related to inputs, weights, and gradients of forward convolution, forward full connection, backward convolution, and backward full connection operators may be quantized and then subjected to a fixed point number computation, and after the computations are completed, the low-precision data may be converted to high-precision data.

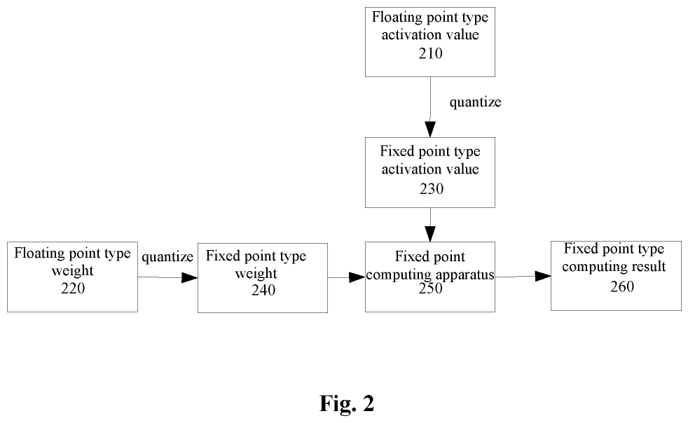

FIG. 2 is a schematic diagram of a hidden layer forward propagation process in a neural network involving a quantization operation to which an embodiment of the present disclosure may be applied.

As shown in FIG. 2, hidden layers (e.g., convolution layers, fully-connected layers) of the neural network are represented by a fixed point computing apparatus 250. An activation value 210 and a weight 220 related to the fixed point computing apparatus 250 are typically floating point type data. The activation value 210 and the weight 220 are quantized respectively to obtain an activation value 230 and a weight 240 of the quantized fixed point type data, which are then provided to the fixed point computing apparatus 250 for the fixed point computation to obtain a computing result 260 of the fixed point type data.

Depending on the structure of the neural network, the computing result 260 of the fixed point computing apparatus 250 may be provided to the next hidden layer of the neural network as an activation value or to an output layer as an output result. Therefore, de-quantization of the computing result may be performed as needed to obtain a computing result of the floating point type data.

FIG. 3 is a schematic diagram of a hidden layer backward propagation process in a neural network involving a quantization operation to which an embodiment of the present disclosure may be applied. As described above, the forward propagation process transfers the information forward until the output produces an error, and the backward propagation process transfers the error information backward to update the weights.

As shown in FIG. 3, a gradient 310 of the floating point type data used in computing of the backward propagation process is quantized to obtain a gradient 320 of the fixed point type data. The fixed point type gradient 320 is provided to a fixed point computing apparatus 330 of a previous hidden layer of the neural network. Likewise, performing computation by the fixed point computing apparatus 330 also requires the corresponding weight and activation value. A weight 340 and an activation value 360 of the floating point type data are shown in FIG. 3, which are quantized to a weight 350 and an activation value 370 of the fixed point type data, respectively. Those skilled in the art will appreciate that although quantization of the weight 340 and activation value 360 is illustrated in FIG. 3, quantization is not required here if the fixed point type weight and activation value have been obtained in the forward propagation process.

The fixed point computing apparatus 330 performs fixed point computing to compute a gradient of the corresponding weight and an activation value based on the fixed point type gradient 320, the current corresponding fixed point type weight 350, and the activation value 370 provided by a subsequent layer. Then, a fixed point type weight gradient 380 computed by the fixed point computing apparatus 330 is dequantized to a floating point type weight gradient 390. Finally, the floating point type weight gradient 390 is used to update the floating point type weight 340 corresponding to the fixed point computing apparatus 330, for example, the corresponding gradient 390 may be subtracted from the weight 340, so that the weights are updated once to reduce the error value. The fixed point computing apparatus 330 may continue to propagate the gradient of the current layer to a previous layer to adjust parameters of the previous layer.

Quantization operations are involved in both the forward and backward propagation processes described above.

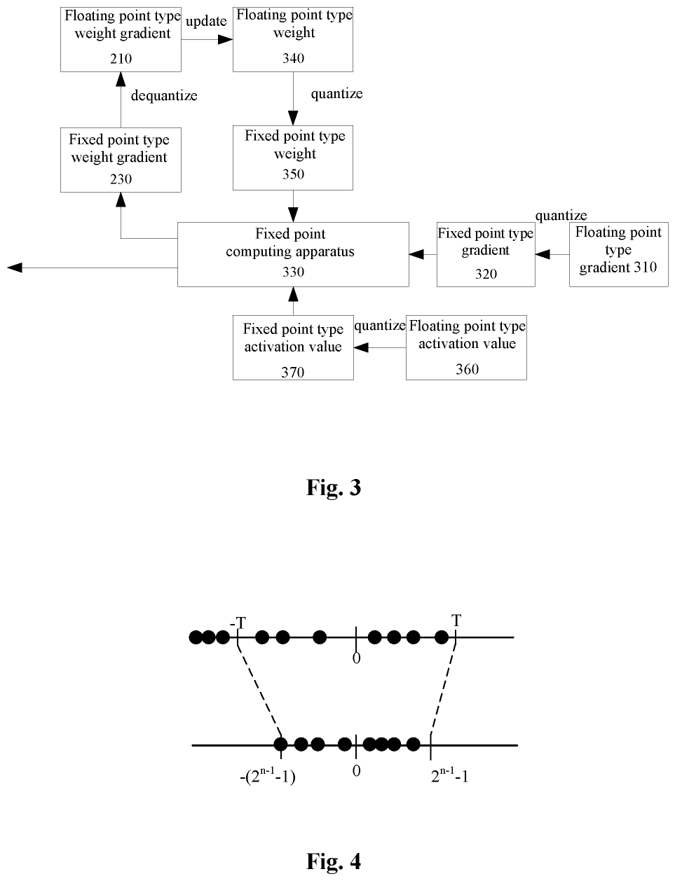

FIG. 4 is a schematic diagram of a quantization operation to which an embodiment of the present disclosure may be applied. In the example shown in FIG. 4, 32-bit floating point type data is quantized into n-bit fixed point type data, where n is a bit width of the fixed point number. The dots on the upper horizontal line of FIG. 4 represent floating point type data to be quantized, and the dots on the lower horizontal line represent the fixed point type data after quantization.

A number domain of the data to be quantized shown in FIG. 4 is asymmetrically distributed with respect to “0”. In this quantization operation, there is a threshold T, which maps ±T to ±(2ⁿ⁻¹−1). As can be seen from FIG. 4, floating point type data beyond the threshold ±T is directly mapped to the fixed point number ±(2ⁿ⁻¹−1) to which the threshold ±T is mapped. For example, three points on the upper horizontal line of FIG. 4 that are less than −T are mapped directly to −(2ⁿ⁻¹−1). Floating point type data within the range of threshold ±T may be, for example, mapped to a range of ±(2ⁿ⁻¹−1) in scale. This mapping is saturation asymmetric.

Although quantization can reduce the computation volume, save computation resources, and the like, it may also reduce the inference precision. Therefore, how to replace the floating point computation unit with the fixed point computation unit to implement a fast fixed point computation and improve peak computing power of the artificial intelligence processor chip while satisfying the required precision of the floating point computation is a technical problem to be solved by the embodiments of the present disclosure.

Based on the above description of the technical problem, one characteristic of the neural network is that it is highly tolerant to input noise. If considering the recognition of objects in a photo, the neural network can ignore the dominant noise and focus on important similarities. This functionality means that the neural network may take low-precision computing as a source of noise, and produce accurate prediction results even in a numerical format that accommodates less information. In the following description, the error caused by quantization is understood from the viewpoint of noise. In other words, the quantization error may be considered as noise associated with raw signals. In this sense, the quantization error is sometimes referred to as quantization noise, and the two are used interchangeably. However, those skilled in the art will appreciate that the quantization noise herein is different from white noise, such as Gaussian noise, that is not signal dependent. For the quantization operation shown in FIG. 4, the above technical problem is to find the optimal threshold T that minimizes the loss in accuracy after quantization.

The noise-based quantization calibration solution in an embodiment of the present disclosure proposes to evaluate the quantization performance using a new quantization difference metric, thereby optimizing the quantization parameters and maintaining the desired quantization inference precision while achieving various advantages (such as reducing the computation volume, saving computation resources, saving storage resources, shortening the processing cycle, and the like) brought by quantization.

According to the noise-based quantization calibration solution of the present disclosure, the total quantization difference metric may be divided into: a metric of the quantized part data of the input data and a metric of the truncated part data of the input data. By dividing the input data into two types according to the quantization operation to evaluate the quantization difference, the influence of quantization on effective information of the data can be more accurately characterized, which may facilitate optimization of the quantization parameters, and provide higher quantization inference precision.

To facilitate understanding of embodiments of the present disclosure, the total quantization difference metric used in embodiments of the present disclosure is firstly explained below.

In some embodiments, the input data (e.g., calibration data) is represented as:

D=[x₁,x₂, . . . ,x_{N}],DϵR^{N} (2).

where N represents the count of data pieces in data D, and R represents a real number field.

When the input data is quantized by the quantization operation shown in FIG. 4, data beyond a threshold ±T will be directly mapped to the fixed point number ±(2ⁿ⁻¹−1) to which the threshold ±T is mapped. Therefore, in the embodiment of the present disclosure, the input data D is divided into the quantized part data DQ and the truncated part data DC according to a truncated threshold T. Accordingly, the total quantization difference metric is divided into: a metric for quantized part data DQ of the input data D and a metric for truncated part data DC of the input data D.

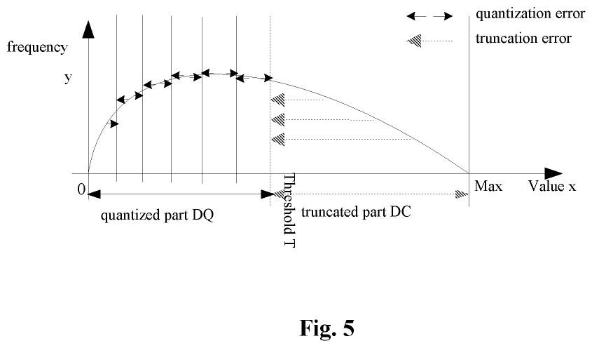

FIG. 5 is a schematic diagram showing quantization errors of the quantized part data and truncation errors of the truncated part data. The abscissa of FIG. 5 represents value x of the input data, and the ordinate represents frequency y of the corresponding value. As can be seen from FIG. 5, the quantized part data DQ is within the range of the threshold T, and each piece of data is quantized to the close fixed point type data. Therefore, the quantization error is relatively small. In contrast, the truncated part data DC goes beyond the range of the threshold T, and is quantized to the fixed point type data corresponding to the threshold T, for example, 2ⁿ⁻¹−1, regardless of the size of the truncated part data DC. Therefore, the truncation error is relatively large and covers a larger scope. It follows that the quantization errors of the quantized part data and the truncated part data have different representations. It should be noted that in the KL divergence calibration method, the quantization error is generally estimated using a histogram of the input data. In an embodiment of the present disclosure, the input data is utilized directly, without employing any form of histogram.

In an embodiment of the present disclosure, by evaluating the quantization difference of the quantized part data DQ and the truncated part data DC respectively, the influence of quantization on effective information of the data can be more accurately characterized, which may facilitate optimization of the quantization parameters, and provide higher quantization inference precision.

In some embodiments, the quantized part data DQ and the truncated part data DC may be expressed as:

$$DQ = [ x \vert \frac{T}{{2}^{n}} \leq Abs ( x ) < T , x ∈ D ] \qquad ( 3 )$$

$$DC = [ x \vert Abs ( x ) \geq T , x ∈ D ] . \qquad ( 4 )$$

where Abs ( ) represents an absolute value, and n is a bit width of the quantized fixed point number.

In this embodiment, data less than

$$\frac{T}{{2}^{n}}$$

is not considered, because this portion of data has less influence on quantization, but has greater influence on the quantization difference metric in the embodiments of the present disclosure through experimental analysis. Therefore, this portion of data is removed.

In an embodiment of the present disclosure, corresponding quantization difference metrics, such as a quantization difference metric DistQ of the quantized part data DQ and a quantization difference metric DistC of the truncated part data DC, are respectively constructed for the quantized part data DQ and the truncated part data DC. Then, the total quantization difference metric Dist(D, T) may be represented as a function of the quantized difference metrics DistQ and DistC. Various functions may be constructed to characterize the relationship between the total quantization difference metric Dist (D,T) and the quantized difference metrics DistQ and DistC.

In some embodiments, the total quantization difference metric Dist(D,T) may be calculated according to the following formula:

Dist(D,T)=DistQ+DistC (5).

In some embodiments, when constructing the quantization difference metrics of the quantized part data DQ and the truncated part data DC, it can be considered from two aspects: a quantization noise amplitude, and correlation of the quantization noise with the input data. On the one hand, the quantization noise amplitude represents a difference in absolute numerical values of quantization errors; and on the other hand, the correlation of the quantization noise with the input data considers a relationship between different representations of the quantized part data and the truncated part data in terms of quantization errors and distribution of the input data with respect to the optimal truncated threshold T.

Specifically, the quantization difference metric DistQ of the quantized part data DQ may be expressed as a function of the quantization noise amplitude of the quantized part data DQ and a correlation coefficient of the quantization noise with the input data; and/or the quantization difference metric DistC of the truncated part data DC may be expressed as a function of the quantization noise amplitude of the truncated part data DC and a correlation coefficient of the quantization noise with the input data. Various functions may be constructed to characterize the relationship of the quantization difference metric with the quantization noise amplitude and the correlation coefficient of the quantization noise with the input data.

In some embodiments, the quantization noise amplitude may be weighted by a correlation coefficient. For example, the quantization difference metric DistQ and the quantization difference metric DistC may be respectively calculated by:

DistQ=(1+EQ)×AQ (6)

DistC=(1+EC)×AC (7).

The quantization noise amplitude AQ of the quantized part data DQ and the quantization noise amplitude AC of the truncated part data DC in the above equations (6) and (7) may be respectively calculated by:

AQ=Σᵢ₌₁^{N}Abs(xᵢ−Quantize(xᵢ,T)),xᵢϵDQ (8)

AC=Σᵢ₌₁^{N}Abs(xᵢ−Quantize(xᵢ,T)),xᵢϵDC (9),

where Quantize(x, T) is a function for quantizing the data x with T as the maximum value. Those skilled in the art will understand that the embodiments of the present disclosure may be applied to various quantization methods. The object of the embodiments of the present disclosure is to find an optimal quantization parameter, or an optimal truncated threshold, that conforms to the currently used quantization method. Depending on the quantization method used, Quantize(x, T) may be represented in different forms. In an example, the data may be quantized by:

$$Quantize ( x , T ) = Ix = round ( \frac{Fx}{{2}^{s}} ) , s = ceil ( {log}_{2} ( \frac{T}{{2}^{n - 1} - 1} ) ) , \qquad ( 10 )$$

where s is a point position parameter, round represents rounding half up, ceil represents rounding up, Ix is an n-bit binary representation value of data x after quantization, and Fx is a floating point value of data x before quantization.

The correlation coefficient EQ of the quantization noise in the quantized part data DQ with the input data and the correlation coefficient EC of the quantization noise in the truncated part data DC with the input data in the above equations (6) and (7) may be respectively calculated by:

$$EQ = \frac{{\sum }_{i = 1}^{N} {x}_{i} \times ( {x}_{i} - Quantize ( {x}_{i} , T ) )}{\sqrt{{\sum }_{i = 1}^{N} {x}_{i}^{2}} \sqrt{{\sum }_{i = 1}^{N} {( {x}_{i} - Quantize ( {x}_{i} , T ) )}^{2}}} , {x}_{i} ∈ DQ \qquad ( 11 )$$

$$EC = \frac{{\sum }_{i = 1}^{N} {x}_{i} \times ( {x}_{i} - Quantize ( {x}_{i} , T ) )}{\sqrt{{\sum }_{i = 1}^{N} {x}_{i}^{2}} \sqrt{{\sum }_{i = 1}^{N} {( {x}_{i} - Quantize ( {x}_{i} , T ) )}^{2}}} , {x}_{i} ∈ DC . \qquad ( 12 )$$

The above describes the total quantization difference metric used in embodiments of the present disclosure. As can be seen from the above description, by dividing the input data into two types (the quantized part data and the truncated part data) according to the quantization operation to evaluate the total quantization difference metric, the influence of quantization on effective information of the data can be more accurately characterized, which may facilitate optimization of the quantization parameters, and provide higher quantization inference precision. Further, in some embodiments, the quantization difference metric for each type of partial data considers two aspects: a quantization noise amplitude, and correlation of the quantization noise with the input data. Therefore, the influence of quantization on effective information of the data can be more accurately characterized. The total quantization difference metric Dist(D, T) described above may be used to calibrate the quantization noise of the computation data in the neural network.

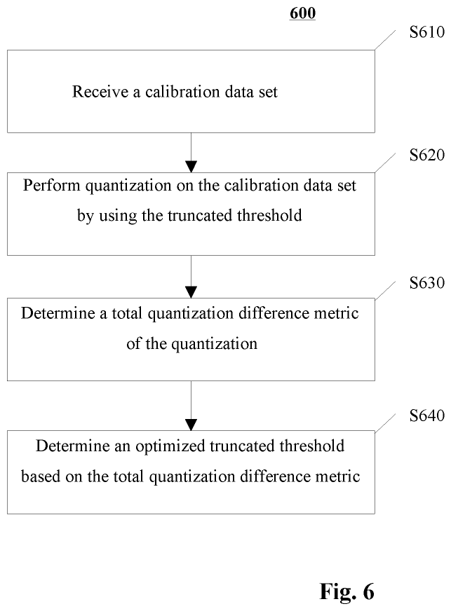

FIG. 6 is a schematic flowchart of a method 600 for calibrating quantization noise according to an embodiment of the present disclosure. The method 600 for calibrating quantization noise may be performed, for example, by a processor. The technical solution shown in FIG. 6 is used to determine a calibrated/optimized quantization parameter (e.g., a truncated threshold T), which is used in quantization of data (e.g., activation values, weights, gradients, etc.) in a neural network operation process by an artificial intelligence processor to confirm the quantized fixed point type data. The quantized fixed point type data may be used by the artificial intelligence processor for training, tuning, or inference of the neural network.

As shown in FIG. 6, in a step S610, a processor receives input data D. The input data D is, for example, a calibration data set or a sample data set prepared for calibrating quantization noise. The input data D may be received from a cooperative processing circuit in a neural network environment to which an embodiment of the present disclosure is applied.

If there is a relatively large amount of input data, the calibration data set may be provided to the processor in batches.

For example, in some examples, the calibration data set may be represented as:

D=[D₁,D₂, . . . ,D_{B}],DᵢϵR^{N×S},iϵ[1 . . . B] (13),

where B represents the count of data batches; N represents a size of the data batch, in other words, the count of data samples in each data batch; S is the count of data pieces in a single data sample; and R represents a real number field.

Next, in a step S620, the processor performs quantization on the input data D using the truncated threshold. The quantization of the input data may be performed in various manners. For example, the quantization may be performed using equation (10) as described above, and will not be described in detail here.

Then, in a step S630, the processor determines a total quantization difference metric of the quantization performed in the step S620. The input data is divided into quantized part data and truncated part data according to the truncated threshold, and the total quantization difference metric is determined based on a quantization difference metric of the quantized part data and a quantization difference metric of the truncated part data.

Further, in some embodiments, the quantization difference metric of the quantized part data and/or the quantization difference metric of the truncated part data may be determined based on at least two of: a quantization noise amplitude, and a correlation coefficient of the quantization noise with a corresponding quantized data.

Specifically, in some embodiments, for example, the input data may be divided into the quantized data part DQ and the truncated data part DC with reference to the above equations (3) and (4). Then, for example, with reference to the above equations (8) and (9), the quantization noise amplitudes AQ and AC of the quantized data part DQ and the truncated data part DC may be calculated, respectively; and, for example, with reference to the above equations (11) and (12), the correlation coefficients EQ and EC of the quantization noise of the quantized data part DQ and the truncated data part DC with the respective quantized data may be calculated, respectively.

Next, for example, with reference to the above equations (6) and (7), the quantization difference metrics DistQ and DistC of the quantized data part DQ and the truncated data part DC may be calculated, respectively. Finally, a total quantization difference metric may be calculated with reference to, for example, the above equation (5).

Continuing with FIG. 6, the method 600 may proceed to a step S640, where the processor determines an optimized truncated threshold based on the total quantization difference metric determined in the step S630. In this step, the processor may select the truncated threshold that minimizes the total quantization difference metric as the calibrated/optimized truncated threshold.

In some embodiments, when the input data or calibration data set includes a plurality of data batches, the processor may determine a total quantization difference metric corresponding to each data batch, then determine a total quantization difference metric corresponding to the entire calibration data set considering the total quantization difference metrics of all batches as a whole, and thereby determining the calibrated/optimized truncated threshold. In an example, the total quantization difference metric of the calibration data set may be a sum of the total quantization difference metrics of all batches.

A schematic flow of a method for calibrating quantization noise according to an embodiment of the present disclosure is described above with reference to FIG. 6. In practical operations, the calibrated/optimized truncated threshold may be determined by searching. Specifically, for a given calibration data set D, the total quantization difference metric Dist (D, Tc) corresponding to each candidate truncated threshold Tc is searched and compared within a possible range of truncated thresholds (referred to herein as search space) to determine a candidate truncated threshold Tc corresponding to the optimal total quantization difference metric as the calibrated/optimized truncated threshold.

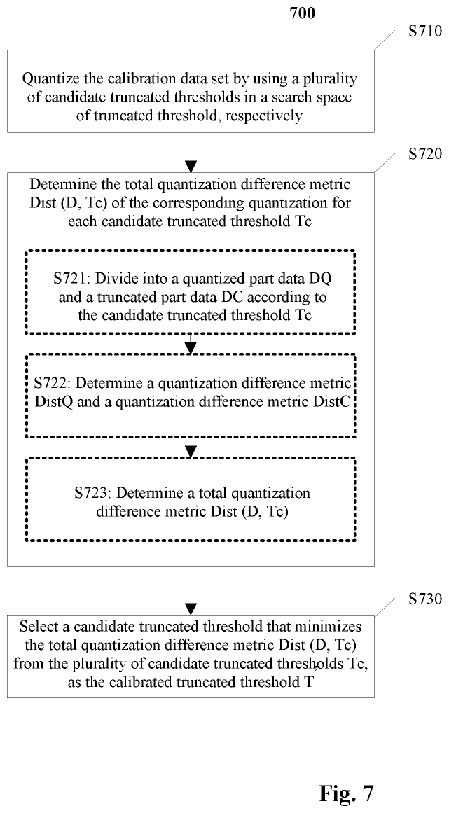

FIG. 7 is a schematic logic flow 700 for implementing the method for calibrating quantization noise according to an embodiment of the present disclosure. The flow 700 may be performed by a processor on, for example, a calibration data set.

As shown in FIG. 7, in a step S710, the calibration data set is quantized using a plurality of candidate truncated thresholds Tc in a search space of truncated threshold, respectively.

In some embodiments, the search space of the truncated threshold may be determined based on at least the maximum value of the calibration data set. The search space may be set to (0, max], where max represents the maximum value of the calibration data set. When calibration is performed using the calibration data set in batches, max may be initialized to max=max (D₁), where max (D₁) is the maximum value in a first batch of calibration data.

The count of candidate truncated thresholds Tc present in the search space may be referred to as search precision M. The search precision M may be set in advance. In some examples, the search precision M may be set to 2048. In other examples, the search precision M may be set to 64. The search precision determines a search interval. Therefore, the j^{th} candidate truncated threshold Tc in the search space may be determined at least partially based on the preset search precision M by:

$${Tc}_{j} = \frac{max \times j}{M} , j ∈ [ 1 … M ] .$$

After the candidate truncated threshold Tc is determined, the quantization of the input data may be performed in various manners. For example, the quantization may be performed using equation (10) as described above.

Next, in a step S720, the total quantization difference metric Dist (D, Tc) of the corresponding quantization is determined for each candidate truncated threshold Tc. Specifically, the following sub-steps may be included.

At a sub-step S721, the calibration data set D is divided into the quantized part data DQ and the truncated part data DC according to the candidate truncated threshold Tc with reference to the above equations (3) and (4). In this embodiment, equations (3) and (4) may be adjusted to:

$$DQ = [ x \vert \frac{Tc}{{2}^{n}} \leq Abs ( x ) < Tc , x ∈ D ] ,$$

$$DC = [ x \vert Abs ( x ) \geq Tc , x ∈ D ] ,$$

where n is a bit width of the quantized data after quantization.

At a sub-step S722, a quantization difference metric DistQ of the quantized part data DQ and a quantization difference metric DistC of the truncated part data DC are determined, respectively. For example, the quantization difference metric DistQ and the quantization difference metric DistC may be determined with reference to the above equations (6) and (7):

$$DQ = [ x \vert \frac{Tc}{{2}^{n}} \leq Abs ( x ) < Tc , x ∈ D ] ,$$

$$DC = [ x \vert Abs ( x ) \geq Tc , x ∈ D ] ,$$

where AQ represents a quantization noise amplitude of the quantized part data DQ, EQ represents a correlation coefficient of the quantization noise of the quantized part data DQ with the quantized part data DQ, AC represents a quantization noise amplitude of the truncated part data DC, and EC represents a correlation coefficient of the quantization noise of the truncated part data DC with the truncated part data DC.

Further, with reference to the above equations (8) and (9), the quantization noise amplitudes AQ and AC of the quantized data part DQ and the truncated data part DC may be calculated, respectively; and, for example, with reference to the above equations (11) and (12), the correlation coefficients EQ and EC of the quantization noise of the quantized data part DQ and the truncated data part DC with the respective quantized data may be calculated, respectively. In this embodiment, the above equations may be adjusted to:

$$AQ = {\sum }_{i = 1}^{N} Abs ( {x}_{i} - Quantize ( {x}_{i} , Tc ) ) , {x}_{i} ∈ DQ ,$$

$$AC = {\sum }_{i = 1}^{N} Abs ( {x}_{i} - Quantize ( {x}_{i} , Tc ) ) , {x}_{i} ∈ DC ,$$

$$EQ = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} , {x}_{i} ∈ DQ ,$$

$$EC = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} , {x}_{i} ∈ DC ,$$

where N represent the count of data pieces in the current calibration data set D, and Quantize(x, Tc) is a function for quantizing the data x with Tc as the maximum value.

At a sub-step S723, a corresponding total quantization difference metric Dist (D, Tc) is determined based on the quantization difference metrics DistQ and DistC calculated in the sub-step S722. In some embodiments, the corresponding total quantization difference metric Dist (D,Tc) may be determined by, for example:

Dist(D,Tc)=DistQ+DistC.

Finally, in a step S730, a candidate truncated threshold that minimizes the total quantization difference metric Dist (D, Tc) is selected from the plurality of candidate truncated thresholds Tc as the calibrated/optimized truncated threshold T.

In some embodiments, when the calibration data set includes a plurality of data batches, the processor may determine a total quantization difference metric corresponding to each data batch, then determine a total quantization difference metric corresponding to the entire calibration data set considering the total quantization difference metrics of all batches as a whole, and thereby determining the calibrated/optimized truncated threshold. In an example, the total quantization difference metric of the calibration data set may be a sum of the total quantization difference metrics of all batches. The above computing may be expressed as, for example:

$$T = \frac{max \times j}{M} , j = {argmin}_{j} {\sum }_{i = 1}^{B} Dist ( Di , {Tc}_{j} ) ,$$

where B represents the count of data batches.

The solution for calibrating quantization noise according to an embodiment of the present disclosure is described above with reference to the flowchart.

The inventor has made experiments and comparison of the aforementioned KL divergence calibration method and the method for calibrating quantization noise of the embodiment of the present disclosure on classification models MobileNetV1, MobileNetV2, ResNet 50 V1.5, DenseNet121, and translation model GNMT. Different batch sizes B, different batch counts N and different search accuracies M are adopted in the experiments.

Experimental results show that the method for calibrating quantization noise of the embodiment of the present disclosure achieves similar performance to KL on MobileNetV1; better performance than KL on MobileNetV2 and GNMT; and a bit lower performance than KL on ResNet 50 and DenseNet 121. In summary, the embodiments of the present disclosure provide a new solution for calibrating quantization noise, which can calibrate a quantization parameter (e.g., a truncated threshold) to maintain certain quantization inference precision while achieving various advantages (such as reducing the computation volume, saving computation resources, saving storage resources, shortening the processing cycle, and the like) brought by quantization. The solution for calibrating quantization noise of the embodiments of the present disclosure is especially suited for neural networks with data more centralized and more difficult to quantize, such as the MobileNet series models and the GNMT model.

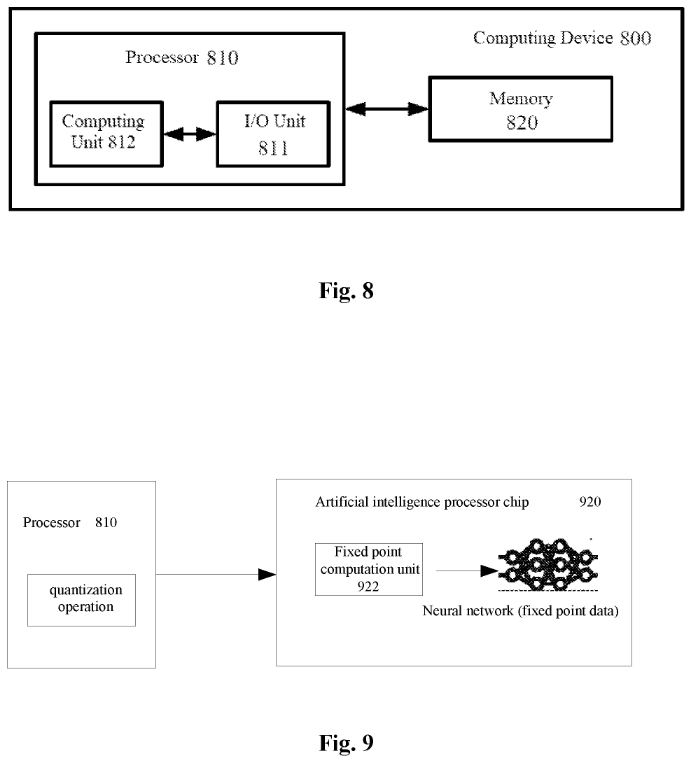

FIG. 8 is a block diagram showing hardware configuration of a computing device 800 that may implement the solution for calibrating quantization noise according to an embodiment of the present disclosure. As shown in FIG. 8, the computing device 800 may include a processor 810 and a memory 820. In the computing device 800 of FIG. 8, only the constituent elements related to the present embodiment are shown. Therefore, it will be apparent to those of ordinary skill in the art that: the computing device 800 may further include some conventional constituent elements different from those shown in FIG. 8. For example: a fixed point computation unit.

The computing device 800 may correspond to a computing apparatus with various processing functions, such as to generating a neural network, training or learning a neural network, quantizing a floating point type neural network into a fixed point type neural network, or retraining a neural network. For example, the computing device 800 may be implemented in various types of devices, such as a personal computer (PC), a server device, a mobile device, and the like.

The processor 810 controls all functions of computing device 800. For example, the processor 810 controls all functions of the computing device 800 by executing programs stored in the memory 820 on the computing device 800. The processor 810 may be implemented by a central processing unit (CPU), a graphics processing unit (GPU), an application processor (AP), an artificial intelligence processor chip (IPU), or the like provided in the computing device 800. However, the present disclosure is not limited thereto.

In some embodiments, the processor 810 may include an input/output (I/O) unit 811 and a computing unit 812. The I/O unit 811 may be configured to receive various data, such as a calibration data set. The computing unit 812 may be configured to quantize the calibration data set received via the I/O unit 811 using a truncated threshold to determine a total quantization difference metric for the quantization; and determine an optimized truncated threshold based on the total quantization difference metric. This optimized truncated threshold may be output by the I/O unit 811, for example. The output data may be provided to the memory 820 for reading by other devices (not shown) or may be provided directly to other devices for use.

The memory 820 is hardware for storing various data processed in the computing device 800. For example, the memory 820 may store data processed and to be processed in the computing device 800. The memory 820 may store data sets involved in the neural network operation processed or to be processed by the processor 810, such as data of an untrained initial neural network, intermediate data of a neural network generated during the training process, data of a neural network that completes all training, data of a quantized neural network, and the like. Further, the memory 820 may store applications, drivers, and the like to be driven by the computing device 800. For example: the memory 820 may store various programs related to a training algorithm, a quantization algorithm, a calibration algorithm, or the like of the neural network to be executed by the processor 810. The memory 820 may be a DRAM, but the disclosure is not limited thereto. The memory 820 may include at least one of a volatile memory or a nonvolatile memory. The nonvolatile memory may include a read only memory (ROM), a programmable ROM (PROM), an electrically programmable ROM (EPROM), an electrically erasable programmable ROM (EEPROM), a flash memory, a phase-change RAM (PRAM), a magnetic RAM (MRAM), a resistive RAM (RRAM), a ferroelectric RAM (FRAM), and the like. The volatile memory may include a dynamic RAM (DRAM), a static RAM (SRAM), a synchronous DRAM (SDRAM), a PRAM, an MRAM, an RRAM, a ferroelectric RAM (FeRAM), and the like. In an embodiment, the memory 820 may include at least one of a hard disk drive (HDD), a solid state drive (SSD), a compact flash (CF), a secure digital (SD) card, a Micro-SD card, a Mini-SD card, an xD card, a cache, or a memory stick.

The processor 810 may generate a trained neural network by iteratively training (learning) a given initial neural network. In this state, parameters of the initial neural network is are a high-precision data representation format in the sense of ensuring the processing accuracy of the neural network, such as a data representation format with a floating point precision of 32 bits. The parameters may include various types of data input/output to/from the neural network, such as: input/output neurons, weights, biases, and the like of the neural network. In contrast to the fixed point computation, the floating point computation requires a relatively large computation volume and relatively frequent memory accesses. Specifically, most of the computations processed by the neural network are known as various types of convolution computations. Therefore, in a mobile device with relatively low processing performance (such as a smart phone, a tablet, a wearable devices, an embedded device, or the like), the high-precision data computation of the neural network may lead to insufficient utilization of resources of the mobile device. As a result, in order to drive the neural network operation within the allowable precision loss range and sufficiently reduce the computation volume in the above device, and high-precision data involved in the neural network operation may be quantized and converted into a fixed point number of lower precision.

Considering the processing performance of some device, such as a mobile device, an embedded device, or the like in which the neural network is deployed, the computing device 800 performs the quantization of converting a parameter of the trained neural network into a fixed point type having a specific count of bits, and the computing device 800 transmits the corresponding quantization parameter (e.g., a truncated threshold) to the device in which the neural network is deployed so that a fixed point number computation is performed when the artificial intelligence processor chip performs an computation operation such as training, tuning, and the like. The device in which the neural network is deployed may be an autonomous vehicle, a robot, a smart phone, a tablet device, an augmented reality (AR) device, an internet of things (IoT) device, or the like, which performs voice recognition, image recognition, or the like by a neural network, but the present disclosure is not limited thereto.

The processor 810 retrieves data from the memory 820 during the neural network operation. The data includes at least one of a neuron, a weight, a bias or a gradient, the corresponding truncated threshold is determined using the technical solution shown in FIGS. 6-7, and then used for quantization of the target data during the neural network operation. The quantized data is subjected to neural network operation. The operation includes, but is not limited to, training, tuning, or inferring.

In summary, specific functions of the memory 820 and the processor 810 of the computing device 800 provided in the described implementation can be explained in comparison with the previous implementations in the description and can achieve the technical effects of the previous implementation, which will not be repeated here.

In this implementation, the processor 810 may be implemented in any suitable manner. For example, the processor 810 may take the form of, for example, a microprocessor or processor, or a computer readable medium that stores computer readable program codes (e.g., software or firmware) executable by the (micro)processor, a logic gate, a switch, an application specific integrated circuit (ASIC), a programmable logic controller and an embedded microcontroller, or the like.

FIG. 9 is a schematic diagram showing an application in which the computing device for calibrating quantization noise in a neural network according to an embodiment of the present disclosure is applied to an artificial intelligence processor chip. Referring to FIG. 9, as described above, in a computing device 800 such as a PC, a server, or the like, a processor 810 performs a quantization operation to quantize floating point data involved in neural network operation into fixed point numbers, and the obtained quantized fixed point numbers are then used by a fixed point computation unit 922 on an artificial intelligence processor chip 920 for training, tuning, or inferring. The artificial intelligence processor chip is dedicated hardware used to drive a neural network. Since the artificial intelligence processor chip is implemented with a relatively low power or performance, the technical solution of the present disclosure can implement the neural network operation by fixed point numbers with lower precision, which, compared with high-precision data, requires a narrower memory bandwidth when reading the fixed point numbers with lower precision, and may make better use of caches in the artificial intelligence processor chip, and avoid the memory access bottleneck. Meanwhile, when an SIMD instruction is executed on the artificial intelligence processor chip, more computing are implemented within one clock period so that the neural network operation can be performed more quickly.

Furthermore, by comparing a fixed point computation and a high-precision data computation of the same length, especially a fixed point computation and a floating point computation, the floating point computation involves a more complicated computing mode and requires more logic devices to construct a floating point computation unit. In terms of the volume, the floating point computation unit has a volume lager than the fixed point computation unit. Further, the floating point computation unit consumes more resources in processing so that the power consumption difference between the fixed point computation and the floating point computation is typically in orders of magnitude.

In summary, the embodiments of the disclosure can replace a floating point computation unit on an artificial intelligence processor chip with a fixed point computation unit so that the power consumption of the artificial intelligence processor chip is reduced. This is especially important for mobile devices.

In an embodiment of the present disclosure, the artificial intelligence processor chip may correspond to, for example, a neural processing unit (NPU), a tensor processing unit (TPU), a neural engine, or the like, which is a dedicated chip for driving a neural network, but the present disclosure is not limited thereto.

In an embodiment of the present disclosure, the artificial intelligence processor chip may be implemented in a separate device from the computing device 800, and the computing device 800 may be implemented as a functional module that is part of the artificial intelligence processor chip. However, the present disclosure is not limited thereto.

In an embodiment of the present disclosure, an operating system of a general purpose processor (such as a CPU) generates an instruction based on the embodiment of the present disclosure, and sends the generated instruction to an artificial intelligence processor chip (such as a GPU) which execute the instruction to perform the processes of calibrating quantization noise and quantizing of a neural network. In another application, the general purpose processor directly determines the corresponding truncated threshold based on the embodiment of the disclosure, and directly quantizes the corresponding target data according to the truncated threshold, and the artificial intelligence processor chip performs a fixed point computation using the quantized data. Even further, a general purpose processor (such as a CPU) and an artificial intelligence processor chip (such as a GPU) are pipelined, where an operating system of a general purpose processor (such as a CPU) generates an instruction based on the embodiment of the present disclosure and the artificial intelligence processor chip (such as a GPU) performs neural network operation while copying target data. In this manner, some time consumption may be hidden, but the present disclosure is not limited thereto.

In an embodiment of the present disclosure, there is further provided a computer readable storage medium having a computer program stored thereon which, when executed by a processor, causes the processor to perform the above method for calibrating quantization noise in a neural network.

As can be seen, during the neural network operation process, the truncated threshold determined by the embodiment of the disclosure is used in quantization, and used by an artificial intelligence processor for quantizing data during the neural network operation to convert high-precision data into low-precision fixed point numbers, which may reduce the space for data storage involved in the neural network operation process. For example: float32 is converted into fix8, which reduces the model parameter by a factor of 4. Because the space for data storage is reduced, the neural network occupies smaller space when deployed so that more data may be contained in an on-chip memory of the artificial intelligence processor chip, which reduces the memory access data of the artificial intelligence processor chip, and improves the computing performance.

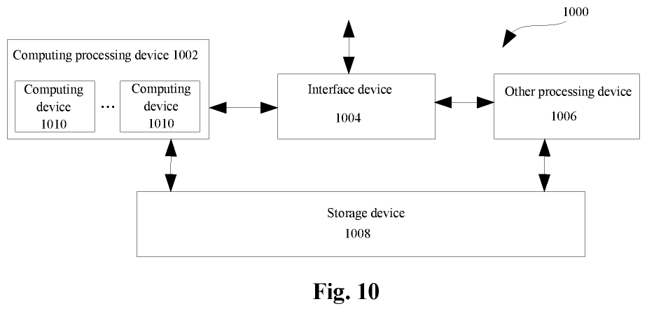

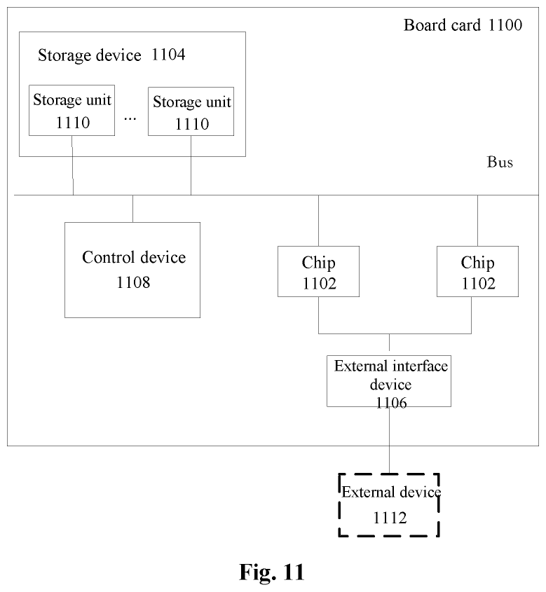

FIG. 10 is a structural diagram of a combined processing apparatus 1000 according to an embodiment of the present disclosure. As shown in FIG. 10, the combined processing apparatus 1000 may include a computing processing device 1002, an interface device 1004, a further processing device 1006, and a storage device 1008. Depending on different application scenarios, the computing processing device may include one or more computing devices 1010 which may be configured to the computing device 800 shown in FIG. 8 to perform the operations described herein in conjunction with FIGS. 6-7.

In different embodiments, the computing processing device of the present disclosure may be configured to perform an operation specified by a user. In an exemplary application, the computing processing device may be implemented as a single-core artificial intelligence processor or a multi-core artificial intelligence processor. Similarly, the one or more computing devices included in the computing processing device may be implemented as an artificial intelligence processor core, or as part of a hardware architecture of an artificial intelligence processor core. When a plurality of computing devices are implemented as an artificial intelligence processor core, or as part of a hardware architecture of an artificial intelligence processor core, the computing processing device of the present disclosure may be regarded as having a single-core structure or a homogeneous multi-core structure.

In an exemplary operation, the computing processing device of the present disclosure may interact with the further processing device via the interface device to jointly complete an operation specified by a user. Depending on different implementations, the further processing device of the present disclosure may include one or more types of general and/or dedicated processors such as central processing units (CPUs), graphics processing units (GPUs), artificial intelligence processors, and the like. These processors may include, but are not limited to, a digital signal processor (DSP), an application specific integrated circuit (ASIC), a field programmable gate array (FPGA) or other programmable logic devices, discrete gates or transistor logic devices, or discrete hardware components, and the count of the processors may be determined according to actual needs. As mentioned previously, the computing processing device of the present disclosure alone may be regarded as having a single-core structure or a homogeneous multi-core structure. However, when considered together, the computing processing device and the further processing device may be considered as forming a heterogeneous multi-core structure.

In one or more embodiments, the further processing device may serve as an interface between the computing processing device of the present disclosure (which may be embodied in a computation device associated with artificial intelligence such as neural network operation) and external data and control to perform basic control including, but not limited to, data transfer, starting and/or stopping of the computing device, and the like. In further embodiments, the further processing device may cooperate with the computing processing device to perform computation tasks.

In one or more embodiments, the interface device may be configured to transmit data and control instructions between the computing processing device and the further processing device. For example, the computing processing device may obtain the input data from the further processing device via the interface device, and write the input data into a storage device (or memory) on chip of the computing processing device. Further, the computing processing device may obtain control instructions from the further processing device via the interface device, and write the control instructions into a control cache on chip of the computing processing device. Alternatively or optionally, the interface device may be further configured to read data from a storage device of the computing processing device and transmit the data to the further processing device.

Additionally or alternatively, the combined processing apparatus of the present disclosure may further include a storage device. As shown in the figure, the storage device may be connected to the computing processing device and the further processing device, respectively. In one or more embodiments, the storage device may be configured to store data of the computing processing device and/or the further processing device. For example, the data may be data that cannot be stored entirely in a storage device inside or on chip of the computing processing device or the further processing device.

In some embodiments, the present disclosure further discloses a chip (e.g., the chip 1102 in FIG. 11). In an implementation, the chip is a system on chip (SoC) and is integrated with one or more combined processing apparatuses as shown in FIG. 7. The chip may be connected to other associated components via an external interface device (e.g., the external interface device 1106 shown in FIG. 11). The related components may include, for example, a camera, a monitor, a mouse, a keyboard, a network card, or a wifi interface. In some application scenarios, a further processing unit (e.g., a video codec) and/or interface unit (e.g., a DRAM interface) or the like may be integrated on the chip. In some embodiments, the disclosure further discloses a chip package structure including the chip as described above. In some embodiments, the present disclosure further discloses a board card, including the chip package structure as described above. The board card will be described in detail below with reference to FIG. 11.

FIG. 11 is a schematic structural diagram of a board card 1100 according to an embodiment of the present disclosure. As shown in FIG. 11, the board card includes a storage device 1104 configured to store data, which includes one or more storage units 1110. The storage device may be connected to and communicate data with the control device 1108 and the chip 1102 as described above via, for example, a bus. Further, the board card further includes an external interface device 1106 configured for a data relay or transfer function between a chip (or chips in a chip package structure) and an external device 1112 (e.g., a server or a computer). For example, the data to be processed may be transferred to the chip by the external device via the external interface device. For another example, a computing result of the chip may be transmitted back to the external device via the external interface device. Depending on different application scenarios, the external interface device may have different interface forms, such as a standard PCIE interface or the like.

In one or more embodiments, the control device in the board card of the present disclosure may be configured to regulate a state of the chip. To this end, in an application scenario, the control device may include a micro controller unit (MCU) configured to regulate a working state of the chip.

From the above description in conjunction with FIGS. 10 and 11, those skilled in the art will appreciate that the disclosure further provides an electronic apparatus or device that may include one or more board cards as described above, one or more chips as described above, and/or one or more combined processing apparatuses as described above.

Depending on different application scenarios, the electronic apparatus or device of the present disclosure may include a server, a cloud server, a server cluster, a data processing device, a robot, a computer, a printer, a scanner, a tablet, a smart terminal, a PC device, an internet of things terminal, a mobile terminal, a phone, a drive recorder, a navigator, a sensor, a camera, a video camera, a projector, a watch, earphones, a mobile storage, a wearable device, a visual terminal, an autopilot terminal, vehicle, a household appliance, and/or a medical device. The vehicle may include an airplane, a ship, and/or an automobile; the household appliance may include a television, an air conditioner, a microwave oven, a refrigerator, an electric cooker, a humidifier, a washing machine, an electric lamp, a gas stove or a range hood; and the medical device may include a nuclear magnetic resonance instrument, a B ultrasonic scanner and/or an electrocardiograph. The electronic device or apparatus of the present disclosure may also be applied to the fields of internet, the internet of things, data centers, energy, transportation, public management, manufacturing, education, power grid, telecommunications, finance, retail, construction sites, medical applications, and the like. Further, the electronic device or apparatus disclosed herein may be further used in application scenarios related to artificial intelligence, big data, and/or cloud computation, such as a cloud, an edge, a terminal, or the like. In one or more embodiments, the electronic device or apparatus with a higher computing power according to the embodiment of the present disclosure may be applied to a cloud device (e.g., a cloud server), while the electronic device or apparatus with less power consumption may be applied to a terminal device and/or an edge device (e.g., a smart phone or a camera). In one or more embodiments, hardware information of the cloud device and hardware information of the terminal device and/or the edge device are compatible with each other so that appropriate hardware resources can be matched from the hardware resources of the cloud device according to the hardware information of the terminal device and/or the edge device to simulate the hardware resources of the terminal device and/or the edge device, thereby achieving unified management, scheduling and cooperative work of end-cloud integration or cloud-edge-end integration.

It should be noted that for the sake of brevity, this disclosure presents some methods and embodiments thereof as a series of actions or combinations thereof, but those skilled in the art will appreciate that the disclosed aspects are not limited by the order of actions described. Accordingly, it will be appreciated by those skilled in the art in light of the disclosure or teachings of the present disclosure that certain steps herein may be performed in other sequences or concurrently. Further, those skilled in the art will appreciate that the embodiments described in this disclosure may be optional embodiments, in that the actions or modules involved are not necessarily required for the implementation of some solution or solutions of the disclosure. In addition, the present disclosure also focuses on the description of some embodiments, depending on the solution. In view of the above, those skilled in the art may understand that portions that are not described in detail in one embodiment of the disclosure may be referred to in other embodiments.

In specific implementations, based on the disclosure and teachings of the present disclosure, one of ordinary skill in the art will appreciate that the several embodiments disclosed in the present disclosure may be implemented in other ways not disclosed herein. For example, for the units in the foregoing embodiments of the electronic device or apparatus, the units are divided based on the logic function, but other division modes may be adopted in the actual implementation. For another example, multiple units or components may be combined or integrated in another system, or some features or functions in a unit or component may be selectively disabled. The connection discussed above in connection with the figures may be direct or indirect coupling between the units or components in terms of the connection relationships between different units or components. In some scenarios, the foregoing direct or indirect coupling involves communication connection utilizing an interface, where the communication interface may support electrical, optical, acoustic, magnetic, or other forms of signal transmission.

In the present disclosure, units described as separate parts may or may not be physically separate, and parts shown as units may or may not be physical units. The aforementioned parts or units may be co-located or distributed over multiple network elements. In addition, some or all of the units may be selected according to actual needs to achieve the purpose of the solution of the embodiment of the present disclosure. In addition, in some scenarios, multiple units in an embodiment of the present disclosure may be integrated into one unit or each unit may exist physically separately.

In some implementation scenarios, the integrated unit may be implemented in the form of a software program module. The integrated unit, if implemented in the form of a software program unit and sold or used as a stand-alone product, may be stored in a computer readable memory. On this basis, when the technical solution of the present disclosure is embodied in the form of a software product (such as a computer readable storage medium), which may be stored in a memory and include several instructions for causing a computer device (e.g., a personal computer, a server, or a network device, etc.) to perform all or part of the steps of the method according to the embodiments of the present disclosure. The memory aforementioned may include, but is not limited to, a U disk, a flash memory disk, a read only memory (ROM), a random access memory (RAM), a mobile hard disk, a disk or compact disk, and other media that can store a program code.

In other implementation scenarios, the integrated unit may be implemented in the form of hardware, including a specific hardware circuit, which may include a digital circuit and/or an analog circuit, etc. The physical implementation of the hardware structure of the circuit may include, but is not limited to, a physical device, which may include, but is not limited to, a transistor or a memristor or the like. In view of this, the various devices described herein (e.g., the computing device or the further processing device) may be implemented by suitable hardware processors, such as CPUs, GPUs, FPGAs, DSPs, ASICs, and the like. Further, the aforementioned storage unit or storage device may be any suitable storage medium (including a magnetic storage medium or a magneto-optical storage medium, etc.), and may be, for example, a variable resistance random access memory (RRAM), a dynamic random access memory (DRAM), a static random access memory (SRAM), an enhanced dynamic random access memory (EDRAM), a high bandwidth memory (HBM), a hybrid memory cube (HMC), a ROM, a RAM, or the like.

Better understanding of the above contents may be obtained in light of the following clauses.

Clause 1. A method performed by a processor for calibrating quantization noise in a neural network, comprising:

receiving a calibration data set;
quantizing the calibration data set by using a truncated threshold;
determining a total quantization difference metric for the quantization; and determining an optimized truncated threshold based on the total quantization difference metric, where the optimized truncated threshold is used by an artificial intelligence processor for quantizing data during a neural network operation;
wherein the calibration data set is divided into quantized part data and truncated part data according to the truncated threshold, and the total quantization difference metric is determined based on a quantization difference metric of the quantized part data and a quantization difference metric of the truncated part data.

Clause 2. The method of clause 1, wherein the quantization difference metric of the quantized part data and/or the quantization difference metric of the truncated part data are determined based on at least two of:

a quantization noise amplitude; and
a correlation coefficient of the quantization noise with corresponding quantized data.

Clause 3. The method of any one of clauses 1 to 2, wherein quantizing the calibration data set by using the truncated threshold includes:

quantizing the calibration data set by using a plurality of candidate truncated thresholds in a search space of truncated threshold, respectively.

Clause 4. The method of clause 3, wherein determining the total quantization difference metric for the quantization includes:

dividing, for each candidate truncated threshold Tc, a calibration data set D into a quantized part data DQ and a truncated part data DC by:

$$DQ = [ x \vert \frac{Tc}{{2}^{n}} \leq Abs ( x ) < Tc , x ∈ D ] ,$$

$$DC = [ x \vert Abs ( x ) \geq Tc , x ∈ D ] ,$$

where n is a bit width of the quantized data after quantization;
determining a quantization difference metric DistQ of the quantized part data DQ and a quantization difference metric DistC of the truncated part data DC, respectively; and
determining the corresponding total quantization difference metric Dist (D,Tc) based on the quantization difference metric DistQ and the quantization difference metric DistC.

Clause 5. The method of clause 4, wherein the quantization difference metric DistQ of the quantized part data DQ and the quantization difference metric DistC of the truncated part data DC are determined respectively by:

DistQ=(1+EQ)×AQ,

DistC=(1+EC)×AC,

where AQ represents a quantization noise amplitude of the quantized part data DQ, EQ represents a correlation coefficient of the quantization noise of the quantized part data DQ with the quantized part data DQ, AC represents a quantization noise amplitude of the truncated part data DC, and EC represents a correlation coefficient of the quantization noise of the truncated part data DC with the truncated part data DC.

Clause 6. The method of clause 5, wherein

the amplitudes AQ and AC of the quantization noise are determined by:

AQ=Σᵢ₌₁^{N}Abs(xᵢ−Quantize(xᵢ,Tc)),xᵢϵDQ,

AC=Σᵢ₌₁^{N}Abs(xᵢ−Quantize(xᵢ,Tc)),xᵢϵDC, and/or

the correlation coefficients EQ and EC are determined by:

$$EQ = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} , {x}_{i} ∈ DQ ,$$

$$EC = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} ,$$

where N represent the count of data pieces in the calibration data set D, and Quantize(x, Tc) is a function for quantizing the data x with Tc as the maximum value.

Clause 7. The method of any one of clauses 4 to 6, wherein the corresponding total quantization difference metric Dist (D,Tc) is determined by:

Dist(D,Tc)=DistQ+DistC.

Clause 8. The method of any one of clauses 4 to 7, wherein determining the optimized truncated threshold based on the total quantization difference metric includes: selecting, from the plurality of candidate truncated thresholds Tc, a candidate truncated threshold that minimizes the total quantization difference metric Dist (D,Tc) as the optimized truncated threshold.

Clause 9. The method of any one of clauses 3 to 8, wherein the search space of the truncated threshold is determined based on at least the maximum value of the calibration data set, and the candidate truncated threshold is determined at least partially based on a preset search precision.

Clause 10. The method of any one of clauses 1 to 9, wherein the calibration data set includes a plurality of batches of data, and the total quantization difference metric is based on a total quantization difference metric of all batches of data.

Clause 11. A computing device for calibrating quantization noise in a neural network, comprising:

at least one processor; and
at least one memory which is in communication with the at least one processor and stores computer readable instructions, wherein the computer readable instructions, when loaded and executed by the at least one processor, cause the at least one processor to perform the method of any one of clauses 1 to 10.

Clause 12. A computer readable storage medium storing program instructions which, when loaded and executed by a processor, cause the processor to perform the method of any one of clauses 1 to 10.

While various embodiments of the present disclosure have been shown and described herein, it will be obvious to those skilled in the art that such embodiments are merely provided by way of example. Numerous modifications, changes, and substitutions will occur to those skilled in the art without departing from the spirit and scope of the present disclosure. It should be understood that various alternatives to the embodiments of the disclosure described herein may be employed in practicing the disclosure. It is intended that the following claims define the scope of the disclosure and that equivalents or alternatives within the scope of these claims are covered thereby.

What is claimed:

1. A method performed by a processor for calibrating quantization in a neural network, comprising:
receiving a calibration data set;
quantizing the calibration data set by using a truncated threshold;
determining a total quantization difference metric for the quantization; and
determining an optimized truncated threshold based on the total quantization difference metric, wherein the optimized truncated threshold is used by a processor for quantizing data during a neural network operation;
wherein the calibration data set is divided into quantized part data and truncated part data according to the truncated threshold, and the total quantization difference metric is determined based on a quantization difference metric of the quantized part data and a quantization difference metric of the truncated part data.

2. The method of claim 1, wherein the quantization difference metric of the quantized part data and/or the quantization difference metric of the truncated part data are determined based on at least two of:
a quantization noise amplitude; and
a correlation coefficient of the quantization noise with corresponding quantized data.

3. The method of claim 1, wherein quantizing the calibration data set by using the truncated threshold includes:
quantizing the calibration data set by using a plurality of candidate truncated thresholds in a search space of truncated threshold, respectively.

4. The method of claim 3, wherein determining the total quantization difference metric for the quantization includes:
dividing, for each candidate truncated threshold Tc, a calibration data set D into a quantized part data DQ and a truncated part data DC by:
$$DQ = [ x \vert \frac{Tc}{{2}^{n}} \leq Abs ( x ) < Tc , x ∈ D ] ,$$
$$DC = [ x \vert Abs ( x ) \geq Tc , x ∈ D ] ,$$
wherein n is a bit width of the quantized data after quantization;
determining a quantization difference metric DistQ of the quantized part data DQ and a quantization difference metric DistC of the truncated part data DC, respectively; and
determining the corresponding total quantization difference metric Dist (D, Tc) based on the quantization difference metric DistQ and the quantization difference metric DistC.

5. The method of claim 4, wherein the quantization difference metric DistQ of the quantized part data DQ and the quantization difference metric DistC of the truncated part data DC are determined respectively by:
DistQ=(1+EQ)×AQ,
DistC=(1+EC)×AC,
wherein AQ represents a quantization noise amplitude of the quantized part data DQ, EQ represents a correlation coefficient of the quantization noise of the quantized part data DQ with the quantized part data DQ, AC represents a quantization noise amplitude of the truncated part data DC, and EC represents a correlation coefficient of the quantization noise of the truncated part data DC with the truncated part data DC.

6. The method of claim 5, wherein,
the amplitudes AQ and AC of the quantization noise are determined by:
AQ=Σᵢ₌₁^{N}Abs(xᵢ−Quantize(xᵢ,Tc)),xᵢϵDQ,
AC=Σᵢ₌₁^{N}Abs(xᵢ−Quantize(xᵢ,Tc)),xᵢϵDC, and/or
the correlation coefficients EQ and EC are determined by:
$$EQ = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} , {x}_{i} ∈ DQ ,$$
$$EC = \frac{{\sum }_{i = 1}^{N} {x}_{i} \times ( {x}_{i} - Quantize ( {x}_{i} , Tc ) )}{\sqrt{{\sum }_{i = 1}^{N} {x}_{i}^{2}} \sqrt{{\sum }_{i = 1}^{N} {( {x}_{i} - Quantize ( {x}_{i} , Tc ) )}^{2}}} , {x}_{i} ∈ DC ,$$
wherein N represent the count of data pieces in the calibration data set D, and Quantize(x, Tc) is a function for quantizing the data x with Tc as the maximum value.

7. The method of claim 4, wherein the corresponding total quantization difference metric Dist (D, Tc) is determined by:
Dist(D,Tc)=DistQ+DistC.

8. The method of claim 4, wherein determining the optimized truncated threshold based on the total quantization difference metric includes:
selecting, from the plurality of candidate truncated thresholds Tc, a candidate truncated threshold that minimizes the total quantization difference metric Dist (D,Tc) as the optimized truncated threshold.

9. The method of claim 3, wherein the search space of the truncated threshold is determined based on at least the maximum value of the calibration data set, and the candidate truncated threshold is determined at least partially based on preset search precision.

10. The method of claim 1, wherein the calibration data set includes a plurality of batches of data, and the total quantization difference metric is based on a total quantization difference metric of all batches of data.

11. (canceled)

12. (canceled)
